(19) United States
(12) Patent Application Publication
(10) Pub. No.: US 2003/0051249 A1
(43) Pub. Date: Mar. 13, 2003

(54) System and method for data insertion (commercials) in client generic data-on-demand broadcast transmissions

(76) Inventor: Khoi Hoang, Pleasanton, CA (US)

Correspondence Address: PERKINS COIE LLP, P.O. BOX 2168, MENLO PARK, CA, 94026, US

(21) Appl. No.: 10/206,929

(22) Filed: Jul. 26, 2002

Related U.S. Application Data
(63) Continuation-in-part of application No. 09/933,696, filed on Aug. 20, 2001.

(51) Int. Cl. H04N 7/025; H04N 7/10; H04N 7/173

(52) U.S. Cl. 725/95; 725/32; 725/93; 725/86

(57) ABSTRACT

A computer implemented universal set-top-box (STB) method for receiving a plurality of data files including at least one DOD data file and at least one non-DOD data file comprising the acts of: receiving at least one DOD data file in a non-client specific manner such that the DOD data file may be viewed nearly on demand; receiving at least one non-DOD data file; providing the EPG data to the user of the universal STB; receiving user input from the user of the universal STB requesting access to the first data file; providing access to the first data file to the user; displaying at least a portion of the DOD data file to the user; and displaying at least a portion of the non-DOD data file to the user.

### CROSS-REFERENCE TO RELATED APPLICATIONS

This application is a continuation-in-part claiming priority to Khoi Hoang's patent applications entitled A METHOD AND APPARATUS FOR TRANSMITTING NON-VOD SERVICES, filed on Oct. 25, 2001, bearing Attorney Docket Number 60595-301801; SELECTIVE INACTIVATION AND COPY-PROTECTION, filed on Aug. 20, 2001, bearing application Ser. No. 09/933,696, CONTROLLING DATA-ON-DEMAND CLENT ACCESS, filed on Jul. 9, 2001, bearing application Ser. No. 09/902,503, DECREASED IDLE TIME AND CONSTANT BANDWIDTH DATA-ON-DEMAND BROADCAST DELIVERY MATRICES, filed on Jun. 25, 2001, bearing application Ser. No. 09/892,017, COUNTERFEIT STB PREVENTION THROUGH PROTOCOL SWITCHING, filed on Jun. 25, 2001, bearing application Ser. No. 09/892,015, UNIVERSAL STB ARCHITECTURES AND CONTROL METHODS filed on May 30, 2001, bearing application Ser. No. 09/870,879, NON CLIENT SPECIFIC ON-DEMAND DATA BROADCAST (Amended) filed on May 31, 2000, bearing application Ser. No. 09/584,832, METHODS FOR PROVIDING VIDEO-ON-DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, all nine being incorporated herein by reference.

### FIELD OF THE INVENTION

This invention relates generally to digital data-on-demand (DOD) broadcast systems. In particular, this invention relates to systems and methods for inserting data files such as advertisements into digital video-on-demand (VOD) provider services.

### BACKGROUND OF THE INVENTION

Video-on-demand (VOD) systems are one type of data-on-demand (DOD) system. In VOD systems, video data files are provided by a server or a network of servers to one or more clients on a demand basis. These systems will be well understood by those of skill in the art. VOD services which may be provided by these systems include movies, television programs, karaoke programs, books, news, etc.

In a conventional VOD architecture, a server or a network of servers communicates with clients in a standard hierarchical client-server model. For example, a client sends a request to a server for a data file (e.g., a video data file). In response to the client request, the server sends the requested file to the client. In the standard client-server model, a client's request for a data file can be fulfilled by one or more servers. The client may have the capability to store any received data file locally in non-volatile memory for later use. The standard client-server model requires a two-way communications infrastructure. Currently, two-way communications requires building new infrastructure because existing cables can only provide one-way communications. Examples of two-way communications infrastructure are hybrid fiber optics coaxial cables (HFC) or all fiber infrastructure. Replacing existing cables is very costly and the resulting services may not be affordable to most users.

In addition, the standard client-server model has many limitations when a service provider (e.g., a cable company) attempts to provide VOD services to a large number of clients. One limitation of the standard client-server model is that the service provider has to implement a mechanism to continuously listen and fulfill every request from each client within the network; thus, the number of clients who can receive service is dependent on the capacity of such a mechanism. One mechanism uses massively-parallel computers having large and fast disk arrays as local servers. However, even the fastest existing local server can only deliver video data streams to about 1000 to 2000 clients at one time. Thus, in order to service more clients, the number of local servers must increase. Increasing local servers requires more upper level servers to maintain control of the local servers.

Another limitation of the standard client-server model is that each client requires its own bandwidth. Thus, the total required bandwidth is directly proportional to the number of subscribing clients. Cache memory within local servers has been used to improve bandwidth limitation but using cache memory does not solve the problem because cache memory is also limited.

In addition to these limitations for transmitting DOD files, other data transmission is similarly limited. A DOD service provider may want to display advertisements or other data to DOD customers, either before, during or after the display of DOD services ordered by a DOD customer. In conventional DOD server systems, these additional data files would have to be transmitted, either before during or after the VOD program and require bandwidth in addition to the bandwidth required to transmit the DOD program itself.

Presently, in order to make video-on-demand services more affordable for clients, existing service providers are increasing the ratio of clients per local server above the local server's capabilities. Typically, a local server, which is capable of providing service to 1000 clients, is actually committed to service 10,000 clients. This technique may work if most of the subscribing clients do not order videos at the same time. However, this technique is set up for failure because most clients are likely to want to view videos at the same time (i.e., evenings and weekends), thus, causing the local server to become overloaded.

Thus, it is desirable to provide video files, such as advertisements separately of VOD files in a client-generic uni-directional manner, and then display these advertisements with these VOD programs in order to conserve transmission bandwidth. It is further desirable to provide a system that is capable of providing on-demand services to a large number of clients over virtually any transmission medium without replacing existing infrastructure. It is further desirable to provide DOD services on a bandwidth that is independent of the number of subscribing customers. Further desirable is the ability to transmit advertisements for display with DOD services using a minimum of additional transmission bandwidth.

### SUMMARY OF THE INVENTION

The present invention provides a system that is capable of transmitting on-demand services to a large number of clients over virtually any transmission medium without replacing existing infrastructure. The present invention further provides DOD services on a bandwidth that is independent of the number of subscribing customers. The present invention additionally provides the ability to transmit advertisements or other non-DOD data files independently of DOD services and display the DOD data files and the non-DOD data files (such as advertisements) in a seamless presentation.

In an exemplary embodiment, at a server side, a computer implemented universal broadcast method comprising the acts of: broadcasting client generic data-on-demand data (DOD) to a plurality of clients via a transmission medium, wherein transmission of the on-demand data (DOD) requires an amount of transmission bandwidth that is independent of the number of the plurality of clients; and broadcasting at least one non-DOD data file to the plurality of clients via the transmission medium; wherein the DOD data is configurable to be displayed to a user; and wherein the at least one non-DOD data file is configurable to be displayed in conjunction with the DOD data file.

In an exemplary embodiment, at a client side, a computer implemented universal set-top-box (STB) method for receiving a plurality of data files including at least one DOD data file and at least one non-DOD data file comprising the acts of: receiving at least one DOD data file in a non-client specific manner such that the DOD data file may be viewed nearly on demand; receiving at least one non-DOD data file; providing the EPG data to the user of the universal STB; receiving user input from the user of the universal STB requesting access to the first data file; providing access to the first data file to the user; displaying at least a portion of the DOD data file to the user; and displaying at least a portion of the non-DOD data file to the user.

In an exemplary embodiment, the present invention also provides a set top box (STB) apparatus for accessing at least one data-on-demand (DOD) data file broadcast over a wide area network as a sequence of data blocks, comprising; an input device for receiving a file request from a user selecting at least one of the DOD broadcast data files; a processor for initiating an authorized file retrieval process to retrieve at least one DOD data block of the sequence of data blocks during a first time interval; a display device for displaying a first portion of the DOD data file after the first time interval, wherein the display device is further operative for displaying at least a portion of the non-DOD data file in conjunction with the DOD data file. In accordance with one embodiment the STB is further operative to display the portion of the non-DOD data file in response to a commercial insertion format. In accordance with yet another embodiment the STB is further operative to receive the commercial insertion format from a service provider, wherein the commercial insertion format is appropriate to a service level corresponding to the user.

A data-on-demand system in accordance with the present invention typically comprises a first set of channel servers, a central controlling server for controlling the first set of channel servers, a first set of up-converters coupled to the first set of channel servers, a combiner/amplifier coupled to the first set of up-converters, and a combiner/amplifier adapted to transmit data via a transmission medium. In an exemplary embodiment, the data-on-demand system further comprises a channel monitoring module for monitoring the system, a switch matrix, a second set of channel servers, and a second set of up-converters. The channel monitoring module is configured to report to the central controlling server when system failure occurs. The central controlling server, in response to a report from the channel monitoring module, instructs the switch matrix to replace a defective channel server in the first set of channel servers with a channel server in the second set of channel servers and a defective up-converter in the first set of up-converters with an up-converter in the second set of up-converters.

Another embodiment of the present invention teaches a universal STB capable of receiving and handling a plurality of digital services such as VOD and digital broadcast. This embodiment teaches a universal STB having a highly flexible architecture capable of sophisticated processing of received data. This architecture includes a databus, a first communication device suitable for coupling to a digital broadcast communications medium, a memory typically including persistent and transient memory bi-directionally coupled to the databus, a digital data decoder bi-directionally coupled to the databus, and a central processing unit (CPU) bi-directionally coupled to the databus. The CPU of this embodiment of the present invention implements a STB control process for controlling the memory, the digital decoder, and the demodulator. The STB control process is operable to process digital data such as that received at the first communications device. Though referred to as a set-top-box, the STB may be of any design suitable for receipt of data transmissions in accordance with the present invention. An STB in accordance with the present invention may encompass advanced televisions and monitors having integral receivers, micro computers and the like.

### BRIEF DESCRIPTION OF THE DRAWINGS

FIG. 1A illustrates an exemplary DOD system in accordance with an embodiment of the invention.

FIG. 1B illustrates an exemplary DOD system in accordance with another embodiment of the invention.

FIG. 2 illustrates an exemplary channel server in accordance with an embodiment of the invention.

FIG. 3 illustrates an exemplary set-top box in accordance with one embodiment of the present invention;

FIG. 4 illustrates an exemplary EPG channel transmission and a plurality of exemplary VOD transmission channels in accordance with one embodiment of the present invention;

FIG. 5 graphically illustrates an exemplary STB method for inserting commercials into data-on-demand services in accordance with one embodiment of the present invention;

FIG. 6A illustrates an exemplary VOD presentation in accordance with one embodiment of the present invention;

FIG. 6B illustrates an alternative exemplary VOD presentation in accordance with one embodiment of the present invention;

FIG. 7 illustrates an exemplary commercial insertion control process in accordance with one embodiment of the present invention; and

FIG. 8 illustrates an exemplary process for controlling commercial insertion for clients with different subscription levels in accordance with one embodiment of the present invention.

### DETAILED DESCRIPTION OF THE INVENTION

The present invention provides a system that is capable of transmitting on-demand services to a large number of clients over virtually any transmission medium without replacing existing infrastructure. The present invention further provides DOD services on a bandwidth that is independent of the number of subscribing customers. The present invention additionally teaches the ability to transmit advertisements or other non-DOD data files with DOD services and seamlessly insert the non-DOD data files (such as advertisements) into the presentation of these DOD services.

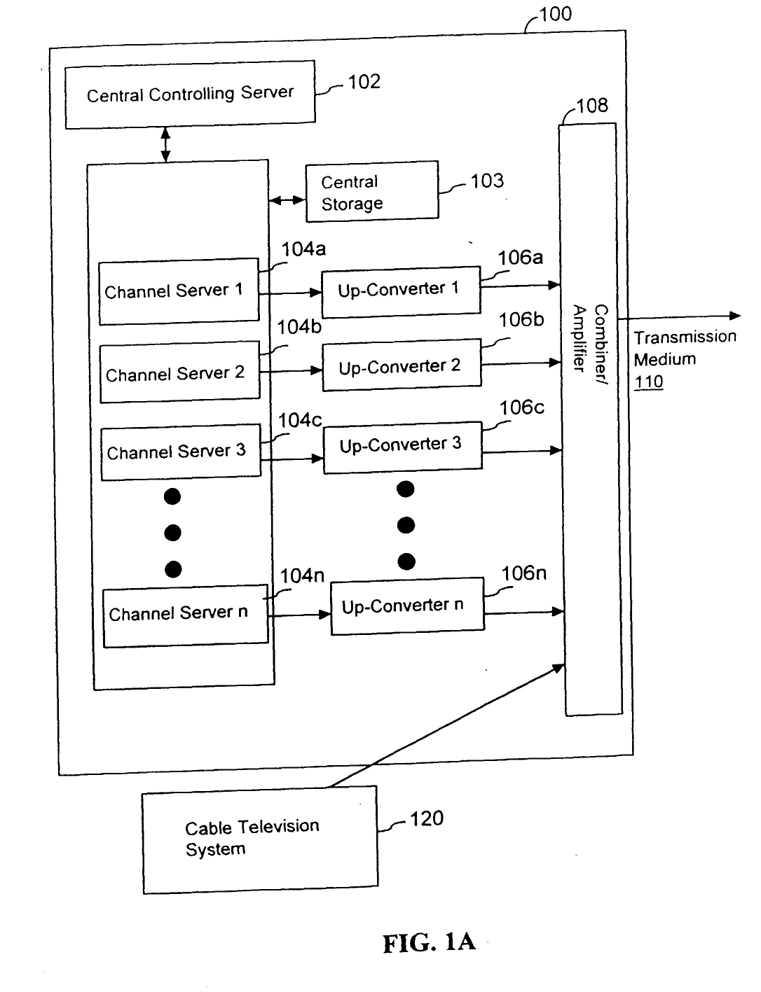

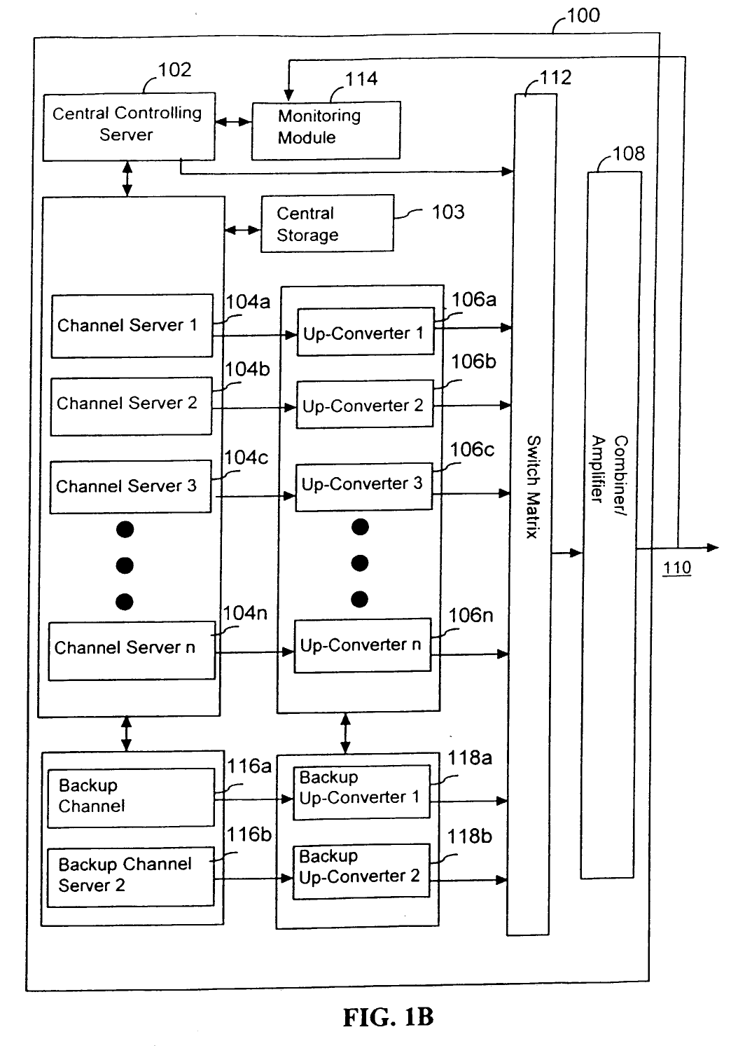

FIG. 1A illustrates an exemplary DOD system 100 in accordance with an embodiment of the invention. In this embodiment, the DOD system 100 provides data files, such as video files, on demand. However, the DOD system 100 is not limited to providing video files on demand but is also capable of providing other data files, for example, game files on demand. The DOD system 100 includes a central controlling server 102, a central storage 103, a plurality of channel servers 104a-104n, a plurality of up-converters 106a-106n, and a combiner/amplifier 108. The central controlling server 102 controls the channel servers 104. The central storage 103 stores data files in digital format. In an exemplary embodiment, data files stored in the central storage 103 are accessible via a standard network interface (e.g., Ethernet connection) by any authorized computer, such as the central controller server 102, connected to the network. Each channel server 104 is assigned to a channel and is coupled to an up-converter 106. The channel servers 104 provide data files that are retrieved from the central storage 103 in accordance with instructions from the central controlling server 102. The output of each channel server 104 is a quadrature amplitude modulation (QAM) modulated intermediate frequency (IF) signal having a suitable frequency for the corresponding up-converter 106. The QAM-modulated IF signals are dependent upon adopted standards. The current adopted standard in the United States is the data-over-cable-systems-interface-specification (DOCSIS) standard, which requires an approximately 43.75 MHz IF frequency. The up-converters 106 convert IF signals received from the channel servers 104 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz. The outputs of the up-converters 106 are applied to the combiner/amplifier 108. The combiner/amplifier 108 amplifies, conditions, and combines the received RF signals then outputs the signals out to a transmission medium 110.

In an exemplary embodiment, the central controlling server 102 includes a graphics user interface (not shown) to enable a service provider to schedule data delivery by a drag-and-drop operation. Further, the central controlling server 102 authenticates and controls the channel servers 104 to start or stop according to delivery matrices. In an exemplary embodiment, the central controlling server 102 automatically selects a channel and calculates delivery matrices for transmitting data files in the selected channel. The central controlling server 102 provides off-line addition, deletion, and update of data file information (e.g., duration, category, rating, and/or brief description). Further, the central controlling server 102 controls the central storage 103 by updating data files and databases stored therein.

In an exemplary embodiment, an existing cable television system 120 may continue to feed signals into the combiner/amplifier 108 to provide non-DOD services to clients. Thus, the DOD system 100 in accordance with the invention does not disrupt present cable television services.

FIG. 1B illustrates another exemplary embodiment of the DOD system 100 in accordance with the invention. In addition to the elements illustrated in FIG. 1A, the DOD system 100 includes a switch matrix 112, a channel monitoring module 114, a set of back-up channel servers 116a-116b, and a set of back-up up-converters 118a-118b. In one embodiment, the switch matrix 112 is physically located between the up-converters 106 and the combiner/amplifier 108. The switch matrix 112 is controlled by the central controlling server 102. The channel monitoring module 114 comprises a plurality of configured set-top boxes, which simulate potential clients, for monitoring the health of the DOD system 100. Monitoring results are communicated by the channel monitoring module 114 to the central controlling server 102. In case of a channel failure (i.e., a channel server failure, an up-converter failure, or a communication link failure), the central controlling server 102 through the switch matrix 112 disengages the malfunctioning component and engages a healthy backup component 116 and/or 118 to resume service.

In an exemplary embodiment, data files being broadcasted from the DOD system 100 are contained in motion pictures expert group (MPEG) files. Each MPEG file is dynamically divided into data blocks and sub-blocks mapping to a particular portion of a data file along a time axis. These data blocks and sub-blocks are sent during a pre-determined time in accordance with three-dimensional delivery matrices provided by the central controlling server 102. A feedback channel is not necessary for the DOD system 100 to provide DOD services. However, if a feedback channel is available, the feedback channel can be used for other purposes, such as billing or providing Internet services.

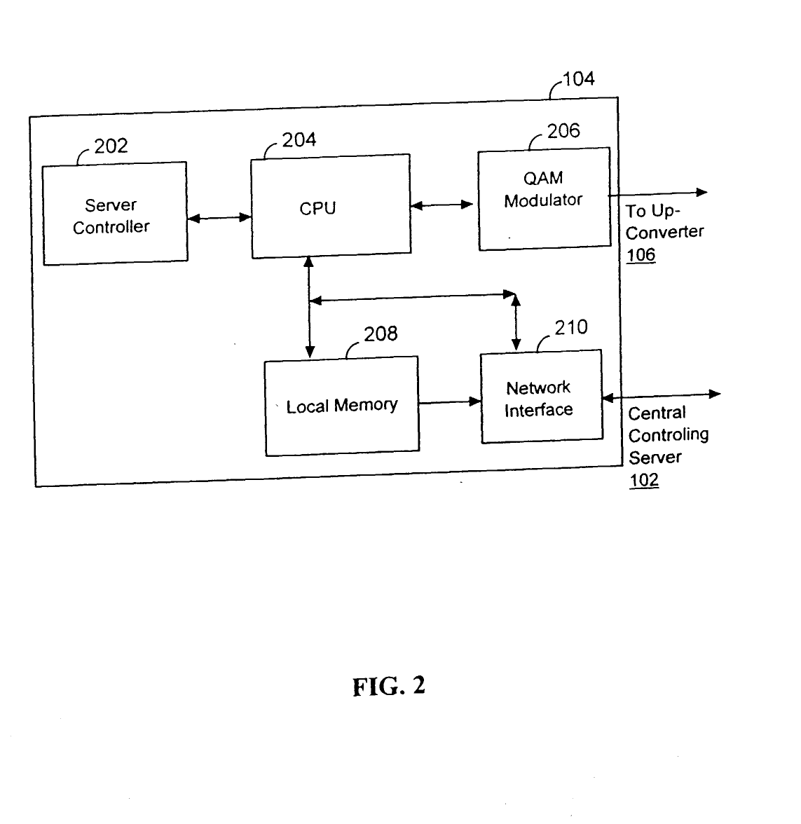

FIG. 2 illustrates an exemplary channel server 104 in accordance with an embodiment of the invention. The channel server 104 comprises a server controller 202, a CPU 204, a QAM modulator 206, a local memory 208, and a network interface 210. The server controller 202 controls the overall operation of the channel server 104 by instructing the CPU 204 to divide data files into blocks (further into sub-blocks and data packets), select data blocks for transmission in accordance with a delivery matrix provided by the central controlling server 102, encode selected data, compress encoded data, then deliver compressed data to the QAM modulator 206. The QAM modulator 206 receives data to be transmitted via a bus (i.e., PCI, CPU local bus) or Ethernet connections. In an exemplary embodiment, the QAM modulator 206 may include a downstream QAM modulator, an upstream quadrature amplitude modulation/quadrature phase shift keying (QAM/QPSK) burst demodulator with forward error correction decoder, and/or an upstream tuner. The output of the QAM modulator 206 is an IF signals that can be applied directly to an up-converter 106.

The network interface 210 connects the channel server 104 to other channel servers 104 and to the central controlling server 102 to execute the scheduling and controlling instructions from the central controlling server 102, reporting status back to the central controlling server 102, and receiving data files from the central storage 103. Any data file retrieved from the central storage 103 can be stored in the local memory 208 of the channel server 104 before the data file is processed in accordance with instructions from the server controller 202. In an exemplary embodiment, the channel server 104 may send one or more DOD data streams depending on the bandwidth of a cable channel (e.g., 6, 6.5, or 8 MHz), QAM modulation (e.g., QAM 64 or QAM 256, and a compression standard/bit rate of the DOD data stream (i.e., MPEG-1 or MPEG-2).

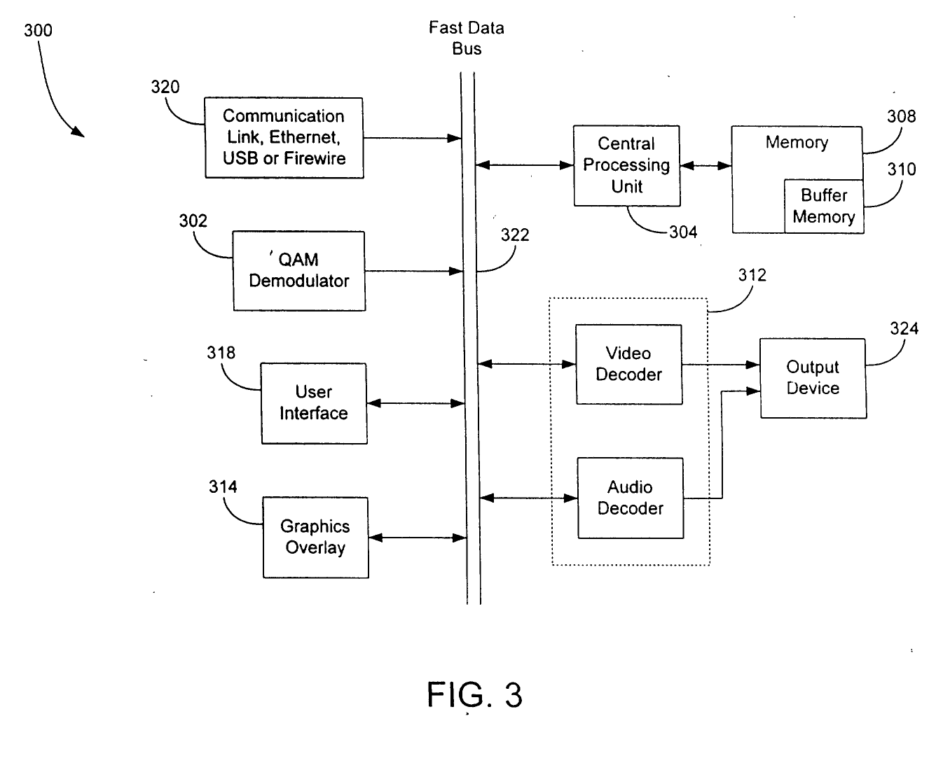

FIG. 3 illustrates a universal set-top box (STB) 300 in accordance with one embodiment of the invention. The STB 300 comprises a QAM demodulator 302, a CPU 304, a local memory 308, a buffer memory 310, a decoder 312 having video and audio decoding capabilities, a graphics overlay module 314, a user interface 318, a communications link 320, and a fast data bus 322 coupling these devices as illustrated. The CPU 302 controls overall operation of the universal STB 300 in order to select data in response to a client's request, decode selected data, decompress decoded data, re-assemble decoded data, store decoded data in the local memory 308 or the buffer memory 310, and deliver stored data to the decoder 312. In an exemplary embodiment, the local memory 308 comprises non-volatile memory (e.g, a hard drive) and the buffer memory 310 comprises volatile memory.

In one embodiment, the QAM demodulator 302 comprises transmitter and receiver modules and one or more of the following: privacy encryption/decryption module, forward error correction decoder/encoder, tuner control, downstream and upstream processors, CPU and memory interface circuits. The QAM demodulator 302 receives modulated IF signals, samples and demodulates the signals to restore data.

In an exemplary embodiment, when access is granted, the decoder 312 decodes data blocks of selected data files into images displayable on an output device 324. The decoder 312 supports commands from a subscribing client, such as play, stop, pause, step, rewind, forward, etc. The decoder 312 provides decoded data to a graphics overlay module 314. The graphics overlay module 314 enhances displayed graphics quality by, for example, providing alpha blending or picture-in-picture capabilities. The graphics overlay module then provides an enhanced display signal to an output device 324 for display to a user. In an exemplary embodiment, the graphics overlay module 314 can be used for graphics acceleration during game playing mode, for example, when the service provider provides games-on-demand services using the system in accordance with the invention. The output device 324 may be any suitable device such as a television, computer, any appropriate display monitor, a VCR, or the like.

The user interface 318 enables user control of the STB 300, and may be any suitable device such as a remote control device, a keyboard, a smartcard, etc. The communications link 320 provides an additional communications connection. This may be coupled to another computer, or may be used to implement bi-directional communication. The data bus 322 is preferably a commercially available “fast” data bus suitable for performing data communications in a real time manner as required by the present invention. Suitable examples are USB, firewire, etc.

In an exemplary embodiment, although data files are broadcast to all cable television subscribers, only the DOD subscriber who has a compatible STB 300 will be able to decode and enjoy data-on-demand services. In one exemplary embodiment, permission to obtain data files on demand can be obtained via a smart card system in the user interface 318. A smart card may be rechargeable at a local store or vending machine set up by a service provider. In another exemplary embodiment, a flat fee system provides a subscriber unlimited access to all available data files.

In preferred embodiments, data-on-demand interactive features permits a client to select at any time an available data file. The amount of time between when a client presses a select button and the time the selected data file begins playing is referred to as a response time. As more resources are allocated (e.g., bandwidth, server capability) to provide DOD services, the response time gets shorter. In an exemplary embodiment, a response time can be determined based on an evaluation of resource allocation and desired quality of service. When combined with the embodiment of placing the first data block in a parallel stream, the response time becomes a factor only of the time it takes to receive and process that first data block.

In one embodiment, the number of data blocks (NUM_OF_BLKS) for each data file can be calculated as follows:

Estimated_BLK_Size=(DataFile Size*TS)/DataFile_Length (1)

BLK SIZE=(Estimated BLK Size+CLUSTER SIZE−1 Byte)/CLUSTER_SIZE (2)

BLK_SIZE_BYTES=BLK_SIZE*CLUSTER_SIZE (3)

NUM_OF_BLKS=(DataFile_Size+BLK_SIZE_BYTES−1 Byte)/BLK_SIZE_BYTES (4)

In equations (1) to (4), the Estimated_BLK_Size is an estimated block size (in Bytes); the DataFile_Size is the data file size (in Bytes); TS represents the duration of a time slot (in seconds); DataFile_Length is the duration of the data file (in seconds); BLK SIZE is the number of clusters needed for each data block; CLUSTER_SIZE is the size of a cluster in the local memory 208 for each channel server 104 (e.g., 64 KBytes); BLK_SIZE_BYTES is a block size in Bytes. In this embodiment, the number of blocks (NUM_OF_BLKS) is equal to the data file size (in Bytes) plus a data block size in Bytes minus 1, Byte and divided by a data block size in Bytes. Equations (1) to (4) illustrate one specific embodiment. A person of skill in the art would recognize that other methods are available to calculate a number of data blocks for a data file. For example, dividing a data file into a number of data blocks is primarily a function of an estimated block size and the cluster size of the local memory 208 of a channel server 104. Thus, the invention should not be limited to the specific embodiment presented above.

The data blocks comprising a data program are transmitted in such a way as to enable a receiving STB nearly instant access to any data program transmitted. This is accomplished by repeatedly re-transmitting each data block of each data program in a predetermined sequence that enables a receiving client to access each data block before it is needed for display to a requesting user. Such methods of broadcasting DOD services are discussed in detail in Khoi Nhu Hoang's patent applications entitled UNIVERSAL STB ARCHITECTURES AND CONTROL METHODS filed on May 30, 2001, SYSTEMS AND METHODS FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, each of which is hereby incorporated by reference.

As disclosed in the above referenced applications, these digital data programs may include movies, concerts, sporting events, e-books, music videos, computer games, or any other digital data file.

In accordance with the present invention, additional non-VOD data files such as advertisements are transmitted independently of these DOD broadcast channels. In accordance with the present invention these advertisements are then displayed to viewers before, during or after the VOD programs. In accordance with one embodiment, these additional non-VOD data files are transmitted on the EPG channel.

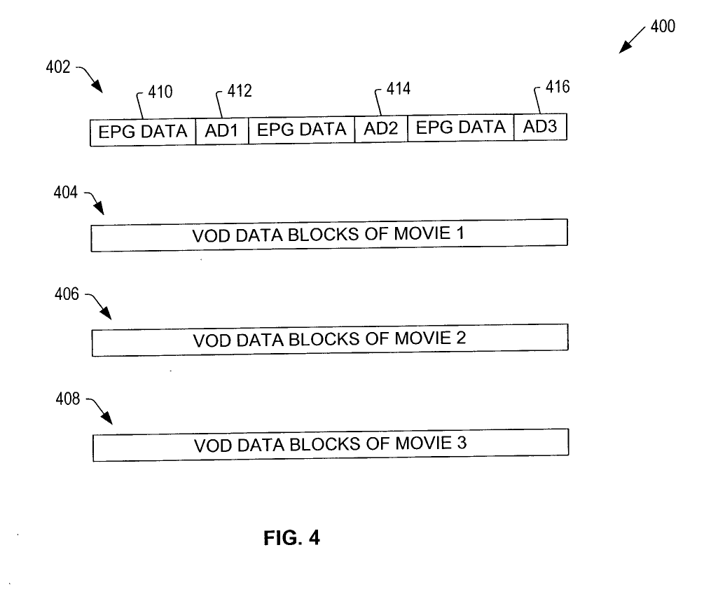

FIG. 4 illustrates an exemplary EPG channel transmission and a plurality of exemplary VOD transmission channels at 400. EPG channel transmission 402 contains EPG data 410. The EPG data 410 may include: listings of available programs; a channel guide; synopsis of available programs; etc.

Also transmitted on the EPG channel 402 is a first advertisement data file 412. First advertisement data file 412 is a commercial for goods or services, such as a visual automobile advertisement. Also transmitted on the EPG channel 402 is a second advertisement data file 414. Second advertisement data file 414 is also a commercial for goods or services, such as an advertisement for designer clothing. Also transmitted on the EPG channel 402 is a third advertisement data file 416. Third advertisement data file 416 is also a commercial for goods or services, such as a trailer for a VOD movie offered at a discount.

On a first DOD (data-on-demand) channel 404 is transmitted a first movie. The movie being transmitted as a sequence of VOD data blocks comprising the first movie. As previously described the VOD data blocks are transmitted such that the first movie may be played on demand without communicating with a broadcast server.

On a second DOD channel 406 is transmitted a second movie. The movie being transmitted as a sequence of VOD data blocks comprising the second movie. As previously described the VOD data blocks are transmitted such that the second movie may be played on demand without communication with a broadcast server.

On a second DOD channel 406 is transmitted a third movie. The movie being transmitted as a sequence of VOD data blocks comprising the third movie. As previously described the VOD data blocks are transmitted such that the third movie may be played on demand without communication with a broadcast server.

The STB 300 (FIG. 3) is configured to receive all four channels 402, 404, 406 and 408 simultaneously. The advertisements 412, 414 and 416 being occassionally stored on an internal hard drive 308 (FIG. 3) for display at some later time. In accordance with one embodiment of the present invention, stored advertisement data files are updated only occasionally. Advertisements may be updated at some regular time period or in response to an update signal from the broadcast server, etc.

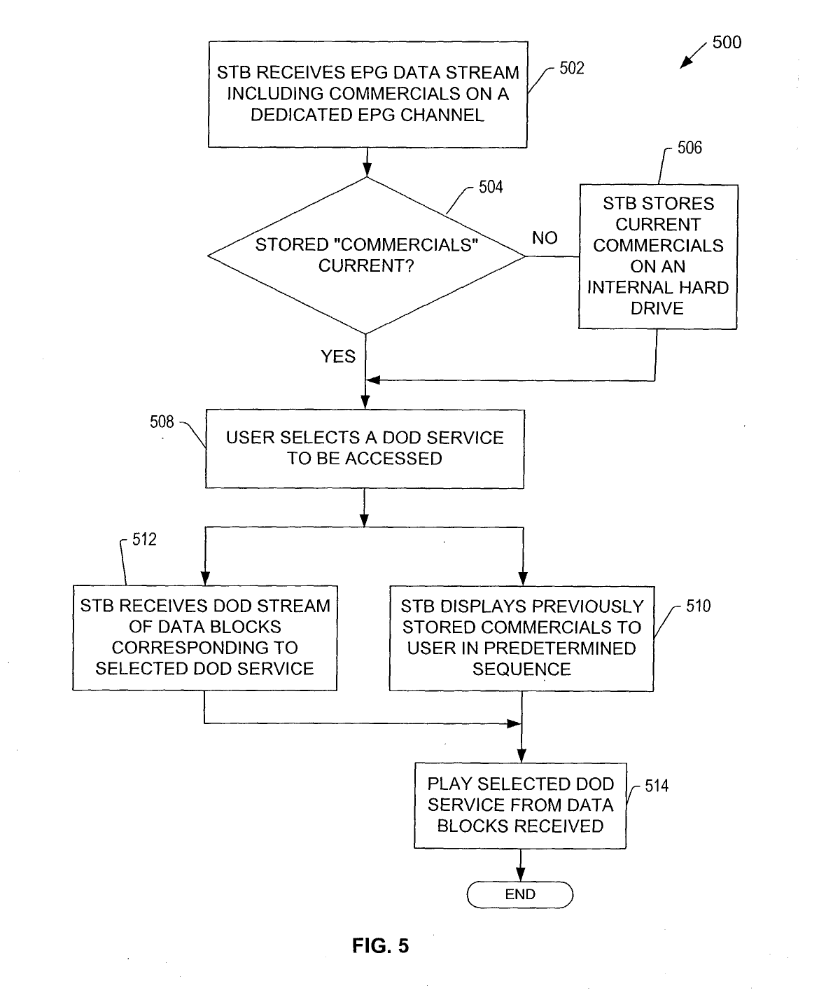

FIG. 5 illustrates an exemplary STB method at 500 for inserting commercials into data-on-demand services. In a step 502 an STB 300 tunes into a dedicated EPG channel, and receives an EPG data stream including non-DOD data files such as commercials. Then in step 504 the STB 300 checks whether commercials previously stored in memory are current. If not the process continues to step 506, in which the STB stores the newer commercials over the older commercials on the STB's memory 308.

Then in step 508, the user selects a DOD service for viewing from a list of DOD files displayed by the EPG program. In step 510, the STB displays one or more of the previously stored commercials to the user in a predetermined format. In accordance to one embodiment, a commercial is displayed before a selected movie as is commonly done at contemporary movie theatres.

In step 512 the STB receives the data blocks of the selected DOD service, and displays the selected DOD service to the user in step 514. In accordance with one embodiment in which a slight delay is required before a selected DOD file may be displayed, a commercial file can be used to provide a more seamless presentation of the DOD service, wherein any delay required to load the first data block of the selected DOD file is masked by displaying a short advertisement.

In accordance with one embodiment, one or more commercials are shown before and after the DOD service is displayed to the user. In accordance with another embodiment, a commercial is displayed as a banner advertisement during the beginning of the DOD presentation. In accordance with such an embodiment, the advertisement may be shown during the opening credits, but not during the DOD story. The above embodiments are only a few examples of many different possible methods of displaying commercials (or other non-DOD data) with VOD or DOD services, which may be implemented in light of the methods of the present invention.

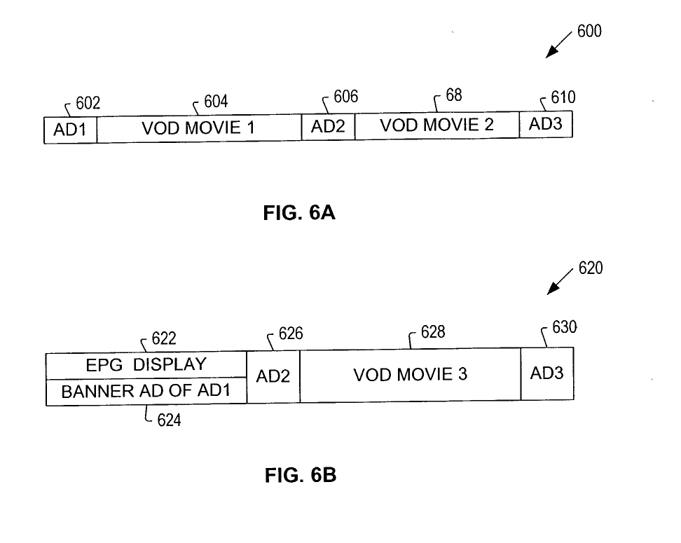

FIG. 6A illustrates an exemplary VOD presentation 600 in accordance with one embodiment of the present invention. After a viewer selects a first and second VOD movie 604, 608 for viewing. STB 300 first displays first advertisement 602, then displays the first VOD movie 604. Then after showing first VOD movie 604, STB 300 displays second advertisement 606. Thus, in accordance with the present invention commercials are inserted before and after video movie presentations.

Then STB 300 displays second movie 608, followed by third advertisement 610. Alternatively, several advertisements could be displayed before a VOD movie in a manner similar to multiple movie trailers being shown before a feature presentation at a contemporary movie theatre. In accordance with one embodiment, public service announcements, or any other non-DOD presentation may be inserted in place of advertisements 602, 606, 610, or any combination thereof. Again the above embodiments are simply examples of infinite possibilities for inserting non-DOD presentations into DOD or near DOD feature presentations.

FIG. 6B illustrates an exemplary VOD presentation 620 in accordance with one embodiment of the present invention. STB 300 displays a visual representation of an EPG (electronic program guide) in conjunction with a banner including one or more commercials 624. The user selects a VOD movie 628 from a menu of available DOD services displayed by the EPG program.

In accordance with one embodiment, commercial display 624 is a video advertisement box that is displayed in a corner of the television screen, while the remainder of the television screen displays various EPG menus. After the user selects a desired movie from the EPG menu, the STB 300 displays a non-DOD commercial 626 to the user, then displays the VOD feature presentation 628. In accordance with one embodiment, the STB 300 displays a third commercial 630 at the conclusion of the feature VOD presentation 628.

In accordance with one embodiment the advertisement file may be displayed as a banner ad similar to those used by internet web providers. Alternatively, such a banner ad may be a simple text message. In accordance with another embodiment the advertisement data file may be displayed whenever a DOD service is not being displayed, such as when an electronic program guide is being viewed. In another embodiment these advertisement data files are displayed in place of third party advertisements, such as broadcast television commercials. In this way DOD services ordered by the client are not diminished by the presence of advertisements.

Though the above examples only include advertisement files, any kind of data file may be transmitted in this fashion. Such files may include stock “tickers” indicating prices of various stocks or commodities. Alternatively such files may include breaking news, weather, or any other information that may be desired.

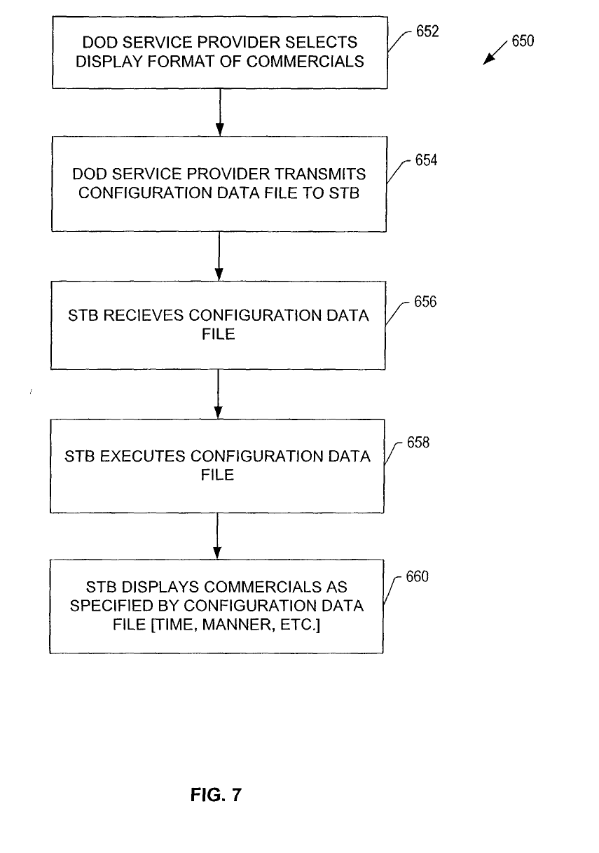

FIG. 7 illustrates an exemplary commercial insertion control process at 650 in accordance with one embodiment of the present invention. In a step 652 a DOD service provider selects a display configuration format for the display of commercial to one or more DOD customers. A selected configuration format may include the insertion of a commercial selected at random from commercials stored on the STB's hard drive, wherein the selected commercial is displayed immediately before a featured VOD selection. Configuration formats may include displaying a commercial before, after, or during a VOD feature. Configuration formats may specify displaying a commercial as a video presentation, audio presentation, a video banner, a picture-in-picture, etc.

In step 654 the DOD service provider transmits the selected configuration format as a data file to all receiving STBs. In accordance with one embodiment, the configuration format data file is transmitted on the EPG channel.

In step 656 the STB 300 receives the configuration data file and stores the configuration data file in internal memory 308. In step 658 the STB executes the stored configuration data file. Thus the selected configuration format is applied to the STB.

In step 660 the STB 300 displays stored commercials (or other specified non-DOD files) as specified by the selected configuration format. The configuration format determining the time and manner in which commercials (or other non-DOD files) are displayed to a user.

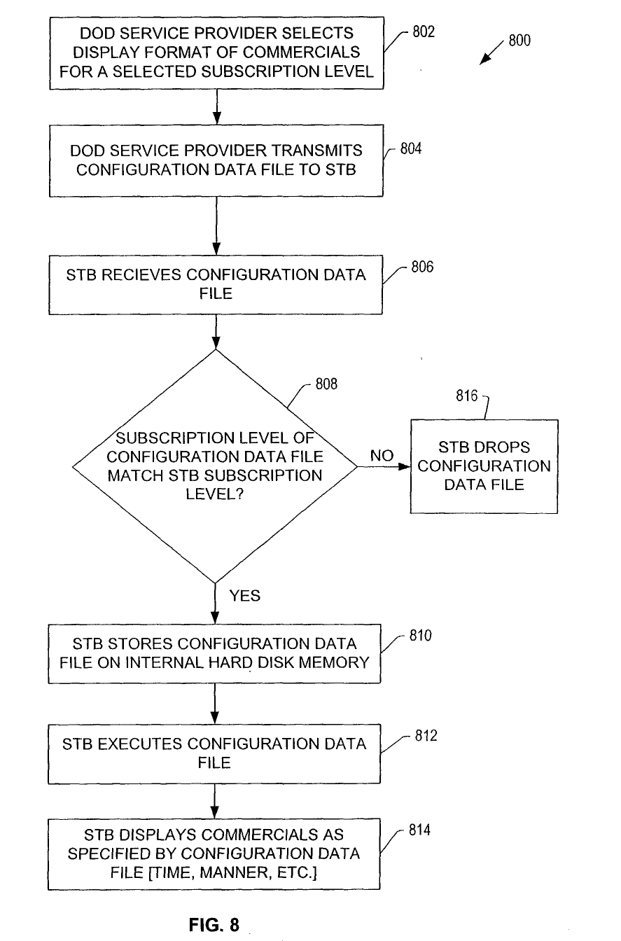

FIG. 8 illustrates a process for controlling commercial insertion for clients with different subscription levels at 800 in accordance with the present invention. In a step 802 a DOD service provider selects a display configuration format for the display of commercials for a selected subscription level. In accordance with such an embodiment every STB has a subscription level indicative of a level of service that a client has selected. For example, for a premium fee, a client could acquire unlimited commercial free access to DOD services. In accordance with the present embodiment, such a client's STB would not display commercial advertisements, though may display movie trailers, public service announcements, coming attractions, etc. Such a client's STB would utilize a commercial configuration format that would not display commercial advertisements. For lower subscription levels (at correspondingly lower premium rates), a customer's STB would display commercial advertisements for goods and services, such as household goods, new cars, food, etc. The use of subscription levels is discussed in detail in Khoi Hoang's patent application entitled: CONTROLLING DATA-ON-DEMAND CLIENT ACCESS, filed on Jul. 9, 2001, bearing application Ser. No. 09/902,503, which is incorporated herein by reference. In this way customers may pay a premium not to view ads.

In a step 804 the DOD server transmits the configuration format as a configuration data file including a header. The header of the file includes a code indicating a subscription level or levels to which the configuration format applies. In accordance with one embodiment, the configuration format data file is transmitted on the EPG channel.

In a step 806 an STB 300 receives the configuration data file. In step 808 the STB 300 compares the subscription level of the STB with the subscription level indicated in the header of the configuration data file. If the subscription levels match, the process continues to step 810. In step 810 the STB stores the configuration data file in internal memory 308. In step 812 the STB executes the stored configuration data file. Thus the selected configuration format is applied to the STB.

In step 814 the STB 300 displays stored commercials (or other specified non-DOD files) as specified by the selected configuration format. The configuration format determining the time and manner in which commercials (or other non-DOD files) are displayed to a user.

In step 808, if the subscription levels of the configuration data file and the STB do not match, the process proceeds to step 816. At step 816 the STB 300 drops the configuration data file. In this manner, the STB will install a configuration format appropriate to a client's subscription level.

In accordance with a preferred embodiment, the STB subscription level may be changed by the DOD service provider via remote control.

In accordance with an alternative embodiment, a different configuration format may be selected for each STB. In such an embodiment, a configuration data file would include a code corresponding to a unique code within an intended STB, and be accessible by only such an intended STB.

In an alternative embodiment only customers with an appropriate service level will view advertisements. In this way customers may pay a premium not to view ads. The use of service levels is discussed in detail in Khoi Hoang's patent application entitled CONTROLLING DATA-ON-DEMAND CLIENT ACCESS.

### GENERAL OPERATION

A service provider can schedule to send a number of data files (e.g., video files) to channel servers 104 prior to broadcasting. These data files will include both DOD data files as well as non-DOD advertisement files (commercials). The central controlling server 102 calculates and sends to the channel servers 104 three-dimensional delivery matrices (ID, time slot, and data block send order). During broadcasting, channel servers 104 consult the three-dimensional delivery matrices to send appropriate data blocks in an appropriate order. Each DOD data file is divided into data blocks so that a large number of subscribing clients can separately begin viewing a data file continuously and sequentially at a random time.

In an exemplary embodiment, a data block size is adjusted to a next higher multiple of a memory cluster size in the local memory 208 of a channel server 104. For example, if a calculated data block length is 720 Kbytes according to equation (1) above, then the resulting data block length should be 768 Kbytes if the cluster size of the local memory 208 is 64 Kbytes. In this embodiment, data blocks should be further divided into multiples of sub-blocks each having the same size as the cluster size. In this example, the data block has twelve sub-blocks of 64 KBytes.

A sub-block can be further broken down into data packets. Each data packet contains a packet header and packet data. The packet data length depends on the maximum transfer unit (MTU) of a physical layer where each channel server's CPU sends data. In the preferred embodiment, the total size of the packet header and packet data should be less than the MTU. However, for maximum efficiency, the packet data length should be as long as possible.

In an exemplary embodiment, data in a packet header contains information that permits the subscriber client's STB 300 to decode any received data and determine if the data packet belongs to a selected data file (e.g., protocol signature, version, ID, or packet type information). The packet header may also contain other information, such as block/sub-block/packet number, packet length, cyclic redundancy check (CRC) and offset in a sub-block, and/or encoding information.

Once received by a channel server 104, data packets are sent to the QAM modulator 206 where another header is added to the data packet to generate a QAM modulated IF output signal. The maximum bit rate output for the QAM modulator 206 is dependent on available bandwidth. For example, for a QAM modulator 206 with 6 MHz bandwidth, the maximum bit rate is 5.05 (bit/symbol)×6(MHz)=30.3 Mbit/sec.

The QAM-modulated IF signals are sent to the up-converters 106 to be converted to RF signals suitable for a specific channel (e.g., for CATV channel 80, 559.250 MHz and 6 MHz bandwidth). For example, if a cable network has high bandwidth (or bit rate), each channel can be used to provide more than one data stream, with each data stream occupying a virtual sub-channel. For example, three MPEG1 data streams can fit into a 6 MHz channel using QAM modulation. The output of the up-converters 106 is applied to the combiner/amplifier 108, which sends the combined signal to the transmission medium 110.

In an exemplary embodiment, the total system bandwidth (BW) for transmitting “N” data streams is BW=N×bw, where bw is the required bandwidth per data stream. For example, three MPEG-1 data streams can be transmitted at the same time by a DOCSIS cable channel having a system bandwidth of 30.3 Mbits/sec. because each MPEG-1 data stream occupies 9 Mbits/sec of the system bandwidth.

Typically, bandwidth is consumed regardless of the number of subscribing clients actually accessing the DOD service. Thus, even if no subscribing client is using the DOD service, bandwidth is still consumed to ensure the on-demand capability of the system.

The STB 300, once turned on, continuously receives and updates a program guide stored in the local memory 308 of a STB 300. In an exemplary embodiment, the STB 300 displays data file information including the latest program guide on a TV screen. Data file information, such as video file information, may include movieID, movie title, description (in multiple languages), category (e.g., action, children), rating (e.g., R, PG13), cable company policy (e.g., price, length of free preview), subscription period, movie poster, and movie preview. In an exemplary embodiment, data file information is sent via a reserved physical channel, such as a channel reserved for firmware update, commercials, and/or emergency information. In another exemplary embodiment, information is sent on a physical channel shared by other data streams.

A subscribing client can view a list of available data files arranged by categories displayed on a television screen. When the client selects one of the available data files, the STB 300 controls its hardware to tune into a corresponding physical channel and/or a virtual sub-channel to start receiving data packets for that data file. The STB 300 examines every data packet header, decodes data in the data packets, and determines if a received data packet should be retained. If the STB 300 determines that a data packet should not be retained, the data packet is discarded. Otherwise, the packet data is saved in the local memory 308 for later retrieval or is temporarily stored, in the buffer memory 310 until it is sent to the decoder 312.

In an exemplary embodiment, the STB 300 responds to subscribing client's commands via infrared (IR) remote control unit buttons, an IR keyboard, or front panel pushbuttons, including buttons to pause, play in slow motion, rewind, zoom and single step. In an exemplary embodiment, if a subscribing client does not input any action for a predetermined period of time (e.g., scrolling program menu, or selecting a category or movie), a scheduled commercial is played automatically. The scheduled commercial is automatically stopped when the subscribing client provides an action (e.g., press a button in a remote control unit). In another exemplary embodiment, the STB 300 can automatically insert commercials while a video is being played. The service provider (e.g., a cable company) can set up a pricing policy that dictates how frequently commercials should interrupt the video being played. If an emergency information bit is found in a data packet header, the STB 300 pauses any data receiving operation and controls its hardware to tune into the channel reserved for receiving data file information to obtain and decode any emergency information to be displayed on an output screen. In an exemplary embodiment, when the STB 300 is idled, it is tuned to the channel reserved for receiving data file information and is always ready to receive and display any emergency information without delay.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A computer implemented universal broadcast method comprising the acts of:
broadcasting content to a plurality of clients on a first channel;
broadcasting at least one data file to said plurality of clients on a second channel, wherein said at least one data file has not been selected for viewing by said clients; and
wherein said at least one data file is configurable to be displayed in conjunction with said content.

2 A computer implemented universal broadcast method comprising the acts of:
broadcasting data to a plurality of clients on a first channel;
broadcasting at least one advertisement to said plurality of clients on a second channel; and
wherein said at least one advertisement is configurable to be displayed in conjunction with said data.

3. The method of claim 2, wherein said advertisement is broadcast at during a first time period such that it may be stored for later use, and wherein a portion of said data is broadcast during a second time period such that it may be stored for later use, such that said advertisement may be viewed in conjunction with said portion of said data may be viewed during a third time period.

4. The method of claim 3, wherein said second time period and said third time period are at least partially coextensive.

5. A computer implemented universal broadcast method comprising the acts of:
broadcasting client generic data-on-demand data (DOD) to a plurality of clients via a transmission medium, wherein transmission of said on-demand data (DOD) requires an amount of transmission bandwidth that is independent of the number of said plurality of clients; and
broadcasting at least one non-DOD data file to said plurality of clients via said transmission medium;
wherein said DOD data is configurable to be displayed to a user; and
wherein said at least one non-DOD data file is configurable to be displayed in conjunction with said DOD data file.

6. A computer implemented method as recited in claim 5, wherein said at least one non-DOD data file is client generic.

7. A computer implemented method as recited in claim 5, wherein configurable to be displayed in conjunction with said DOD data file includes being configurable to be played immediately before said DOD data file.

8. A computer implemented method as recited in claim 5, wherein configurable to be displayed in conjunction with said DOD data file includes being configurable to be played immediately after said DOD data file.

9. A computer implemented method as recited in claim 5, further comprising:
providing at least one configuration format to said plurality of clients, said configuration format determining how said at least one non-DOD data file is displayed in relation to said DOD data.

10. A computer implemented method as recited in claim 5, wherein configurable to be displayed in conjunction with said DOD data file includes being configurable to be displayed contemporaneously with said DOD data file as a visual image occupying at least a portion of a display screen.

11. A computer implemented method as recited in claim 10, wherein displayed contemporaneously with said DOD data file includes being played during at least a portion of the opening credits of said DOD data file.

12. A computer implemented method as recited in claim 10, wherein displayed contemporaneously with said DOD data file includes being played during at least a portion of the closing credits of said DOD data file.

13. A computer implemented method as recited in claim 10, wherein displayed contemporaneously with said DOD data file includes being displayed as a banner advertisement.

14. A computer implemented method as recited in claim 10, wherein said banner ad is a text message.

15. A computer implemented method as recited in claim 5 wherein said non-DOD data file is an advertisement.

16. The method of claim 5, wherein said non-DOD data file is a news program.

17. The method of claim 9, wherein said configuration format determines when non-DOD data files such as commercial advertisements are displayed to a user.

18. The method of claim 9, wherein said configuration format is configured to be stored on a local computer operating system to enable said computer operating system to determine the manner in which said at least one non-DOD data file is displayed to a user.

19. The method of claim 18, wherein said configuration format determines which of a plurality of non-DOD data files are viewed by said client.

20. The method of claim 18, wherein said client has a subscription level, said computer operating system is operative to display said non-DOD data files in response to said subscription level.

21. The method of claim 20, wherein a plurality of configuration formats are provided to said client, said computer operating system is operative to select a configuration format appropriate to said subscription level.

22. The method of claim 18, wherein said configuration format enables client's having a premium subscription level to avoid advertisements.

23. The method of claim 18, wherein a client having a premium subscription level views non-commercial non-DOD data and a client having a basic subscription level views commercial non-DOD data.

24. The method of claim 5, wherein said at least one non-DOD data file is configured to be displayed in an intermission between the display of two DOD feature presentations.

25. A computer implemented universal set-top-box (STB) method for receiving a plurality of data files including at least one DOD data file and at least one non-DOD data file comprising the acts of:
receiving at least one DOD data file in a non-client specific manner such that said DOD data file may be viewed nearly on demand;
receiving at least one non-DOD data file;
providing EPG data to said user of said universal STB;
receiving user input from said user of said universal STB requesting access to said first data file;
providing access to said first data file to said user;
displaying at least a portion of said DOD data file to said user; and
displaying at least a portion of said non-DOD data file to said user.

26. A computer implemented universal set-top-box (STB) method as recited in claim 25, wherein said at least one DOD data file is client generic.

27. A computer implemented universal set-top-box (STB) method as recited in claim 25, wherein displaying at least a portion of said non-DOD data file to said user includes displaying said non-DOD data file immediately before said DOD data file.

28. A computer implemented universal set-top-box (STB) method as recited in claim 25, wherein displaying at least a portion of said non-DOD data file to said user includes displaying said non-DOD data file immediately after said DOD data file.

29. A computer implemented universal set-top-box (STB) method as recited in claim 25, further comprising:
receiving at least one configuration format for determining the manner in which at least some non-DOD data files are displayed in relation to said DOD data.

30. A computer implemented universal set-top-box (STB) method as recited in claim 25, including displaying said non-DOD data file as a visual image occupying at least a portion of a display screen contemporaneously with the displaying of said DOD data file.

31. A computer implemented universal set-top-box (STB) method as recited in claim 30, wherein displaying said non-DOD data file as a visual image contemporaneously with the displaying of said DOD data file includes displaying said non-DOD data file during at least a portion of the opening credits of said DOD data file.

32. A computer implemented universal set-top-box (STB) method as recited in claim 30, wherein displaying said non-DOD data file as a visual image contemporaneously with the displaying of said DOD data file includes displaying said non-DOD data file during at least a portion of the closing credits of said DOD data file.

33. A computer implemented universal set-top-box (STB) method as recited in claim 30, including displaying said non-DOD data file as a banner advertisement over a portion of a display screen.

34. The computer implemented universal set-top-box (STB) method of claim 29, wherein said configuration format determines when non-DOD data files such as commercial advertisements are displayed to a user.

35. The computer implemented universal set-top-box (STB) method of claim 29, further comprising:
storing said configuration format on a local computer operating system to enable said STB to determine the manner in which said at least one non-DOD data file is displayed to a user.

36. The computer implemented universal set-top-box (STB) method of claim 35, wherein said configuration format determines which of a plurality of non-DOD data files are viewed by said user.

37. The method of claim 29, wherein said STB has a subscription level, said computer operating system is operative to display said non-DOD data files in response to said subscription level.

38 The method of claim 37, wherein a plurality of configuration formats are provided to said STB, and said STB is operative to select a configuration format appropriate to said subscription level.

39. The method of claim 28, wherein said configuration format enables users having a premium subscription level to avoid advertisements.

40. The method of claim 28, wherein a user having a premium subscription level views non-commercial non-DOD data and a user having a basic subscription level views commercial non-DOD data.

41. The method of claim 25, wherein said at least one non-DOD data file is displayed during pauses between the display of two DOD feature presentations.

42. The method of claim 25 further comprising:
receiving digital data in a plurality of channels and an electronic program guide (EPG) indicating the nature of data transmitted in each of said plurality of channels, wherein a first one of said plurality of channels includes a data-on-demand (DOD) program providing on-demand data in a non client specific format, said EPG indicating that said data-on-demand program includes a first data file being represented by a first plurality of data blocks, said first plurality of data blocks being provided sequentially within time slots in a manner such that a user of said universal STB may at any time begin accessing said first data file within one time slot;

43. A computer implemented universal set-top-box (STB) method as recited in claim 42, wherein said providing access to said first data file to said user includes the sub-acts of:
tuning said STB to said first channel in order to select data requested by said user;
providing said first data file to an output device selected by said user of said universal STB; and
providing said at least one non-DOD data file to said output device.

44. A computer implemented method as recited in claim 43 wherein said output device is a television.

45. A computer implemented method as recited in claim 43 wherein said output device is a display monitor.

46. A computer implemented method as recited in claim 43 wherein said output device is a video cassette recorder (VCR).

47. A computer implemented method as recited in claim 43 wherein said output device is a computer system.

48. A set top box (STB) apparatus for accessing at least one data-on-demand (DOD) data file broadcast over a wide area network as a sequence of data blocks, comprising;
an input device for receiving a file request from a user selecting at least one of the DOD broadcast data files;
a processor for initiating an authorized file retrieval process to retrieve at least one DOD data block of said sequence of data blocks during a first time interval; and
a display device for displaying a first portion of said DOD data file after said first time interval, wherein said display device is further operative for displaying at least a portion of said non-DOD data file in conjunction with said DOD data file.

49. The apparatus of claim 48, wherein said STB is further operative to display said portion of said non-DOD data file in response to a commercial insertion format.

50. The apparatus of claim 49, wherein said STB is further operative to receive said commercial insertion format from a service provider, wherein said commercial insertion format is appropriate to a service level corresponding to said user.
